(19) United States
(12) Patent Application Publication
(10) Pub. No.: US 2010/0074261 A1
(43) Pub. Date: Mar. 25, 2010

(54) PROVIDING ACCESS TO MULTIPLE DIFFERENT SERVICES BY WAY OF A SINGLE NETWORK IDENTIFIER

(75) Inventor: Rias Muhamed, Austin, TX (US)

Correspondence Address: AT&T Legal Department - T&W;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/236,752

(22) Filed: Sep. 24, 2008

(51) Int. Cl. H04L 12/56

(52) U.S. Cl. 370/395.3

(57) ABSTRACT

The claimed subject matter relates to an architecture that can facilitate access to a plurality of services or a plurality of Virtual Local Area Networks (VLANs) by way of a single Service Set Identifier (SSID). In particular, the architecture can receive a client credential that can be utilized to identify and/or authenticate a client. Based upon the identity, the service provisioned to that client can be selected. Accordingly, one client can access a first service (or VLAN) while another client can access a second service, even though both clients interact with the host network by way of a single SSID.

### TECHNICAL FIELD

The present application relates generally to wireless communications, and more specifically to utilizing a singe Service Set Identifier (SSID) in a Wi-Fi network for providing access to multiple services or Virtual Local Area Networks (VLANs).

### BACKGROUND

Historically, wireless network providers have utilized a service set identifier (SSID) to advertise or broadcast an available service to client devices within range. An SSID is a name used to identify the particular wireless local area network(s) to which a client desires to attach and/or the particular service(s) (provided by the network) the client desires to access. In recent years, network providers who either own or lease resources associated with a physical network have begun offering to customers a variety of different services. Although employing only one physical network, these network providers can logically partition the network into multiple virtual networks or VLANs, each of which can maintain distinct policies.

In order to provide for multiple services over the same physical network, existing solutions rely on using multiple SSIDs. For example, a service provider that offers (1) an ad-supported free service with speed and application restrictions; and (2) a paid service with higher speed and no restrictions would conventionally be implemented by broadcasting two separate SSIDs and allowing users to connect to one or the other. Typically, each SSID is mapped to a different VLAN and service policies are enforced based upon the selected VLAN.

Unfortunately, there are a number of disadvantages associated with utilizing multiple SSIDs. For instance, when a single entity (e.g. network provider) broadcasts multiple SSIDs, customers for that entity can become confused. Additionally, given that an SSID is generally the first identifier that a customer sees, it is the SSID that is commonly used or perceived as the product brand. Hence, using multiple SSIDs necessarily implies multiple product names, which is dilutive of the product brand. Another disadvantage is that switching from one service to another is more difficult. In particular, a customer switching between services must disconnect from one and then reconnect to another. Still another disadvantage is the need to broadcast the multiple SSIDs in the first place, which consumes resources, which can lead to degradation of performance for all customers.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one or more aspects thereof, comprises an architecture that can employ a single service set identifier (SSID) for connecting to multiple services in a wireless communication environment. In accordance therewith and to other related ends, the architecture can broadcast from one or more access points a single SSID indicative of a name for a provider's network. Client devices within range of the various access points can receive the SSID and can, e.g. transmit a request to access the network identified by the SSID. Upon receiving such a network access request from the (unauthenticated) client, the architecture can assign to the client a temporary IP address that maps to an initiation virtual local area network (VLAN).

Typically, the lease for the temporary IP address will be of very short term duration, such as one or two minutes. The initiation VLAN can provide access to client login features, client registration features, client preferences features, service selection features, product or service offers as well as various other suitable features or options. Ultimately, whether an existing client logging in or a new client who registers for a service, a client credential (e.g., activated by user ID/password or the like) can be received by the architecture. Accordingly, these client credentials can be utilized to identify and/or authenticate the client and to select the provisioned service associated with the client.

In accordance therewith, the architecture can select a persistent IP address from among a range of IP addresses that map to a provisioned VLAN for the (authenticated) client and/or the VLAN that hosts the provisioned service. This persistent IP address can then be assigned to the client. Generally, assignment of the persistent IP address will occur upon expiration of the short term lease associated with the temporary IP address and will typically be assigned in direct response to a new request from the client (e.g., a dynamic host configuration protocol (DHCP) request). However, it should be appreciated that the persistent IP address can be assigned even before expiration of the temporary IP address lease and can be instigated by the network provider, e.g., by transmitting a notification that the persistent IP address is now obtainable.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a block diagram of a system that can employ a single service set identifier (SSID) for connecting to multiple services in a wireless communication environment.

FIG. 2 illustrates a block diagram of a system that can employ a single SSID for connecting to multiple VLANs in a wireless communication environment.

FIG. 3 is a block diagram of a system that can initiate a connection with access to multiple VLANs or services by way of a single SSID.

FIG. 4 illustrates a block diagram of a system that illustrates one embodiment of the claimed subject matter.

FIG. 5 illustrates an exemplary flow chart of procedures that define a method for facilitating access to a plurality of wireless services based upon a single SSID.

FIG. 6 is an exemplary flow chart of procedures that define a method for facilitating access to a plurality of wireless VLANs based upon a single SSID.

FIG. 7 depicts an exemplary flow chart of procedures that define a method for generating a temporary IP address to an unauthenticated client in connection with accessing multiple services or VLANs by way of a single SSID.

FIG. 8 illustrates an exemplary flow chart of procedures that define a method for generating a persistent IP address to an authenticated client in connection with accessing multiple services or VLANs by way of a single SSID.

FIG. 9 depicts an exemplary flow chart of procedures defining a method for utilizing a single SSID for enabling access to multiple services or VLANs.

FIG. 10 illustrates a block diagram of a computer operable to execute the disclosed architecture.

FIG. 11 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” or the like can, but need not, refer to a computer-related entity, either hardware, a combination of hardware and software, software, or software in execution. For example, a component might be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Moreover, the word “exemplary” is used herein to mean serving as an example, instance, or illustration. Any aspect, feature, design, or implementation described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” Therefore, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

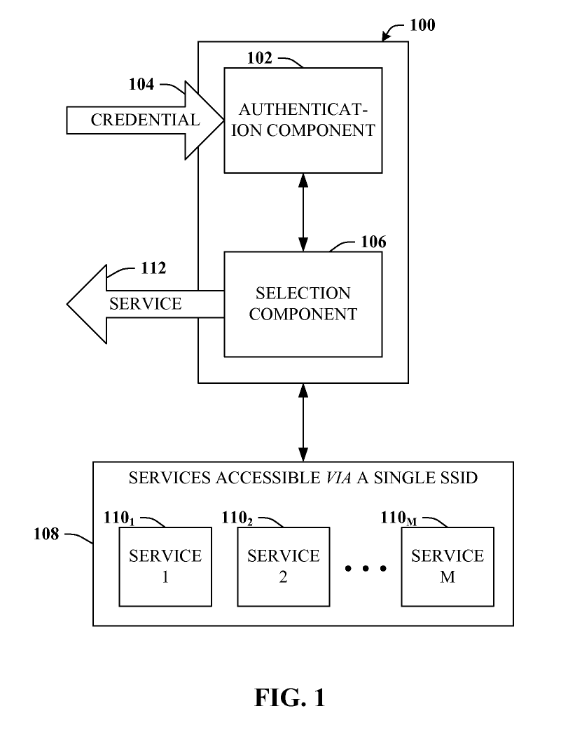

Referring now to the drawings, with reference initially to FIG. 1, system 100 that can employ a single service set identifier (SSID) for connecting to multiple services in a wireless communication environment is depicted. Generally, system 100 can include authentication component 102 that can receive, either directly or indirectly, client credentials 104 that are associated with a client. Authentication component 102 can further identify or authenticate an associated client based upon client credentials 104. Suitable identification and/or authentication can be based upon well-known security or encryption principles, protocols, techniques, or standards such as, e.g., wired equivalency privacy (WEP); wireless fidelity (Wi-Fi) protected access (WPA) or WPA2, which is a standard defined by IEEE 802.11i; extensible authentication protocol (EAP) or lightweight extensible authentication protocol (LEAP), both of which are standards defined by IEEE 802.1X; remote authentication dial in user service (RADIUS) defined by Internet Society (ISOC) documents RFC 2138 and RFC 2139; and so on.

In addition, system 100 can further include selection component 106 that can be configured to facilitate access to plurality 108 of wireless services, such as services 110₁-110_{M}, where M is an integer greater than or equal to 2. As used herein, services 110₁-110_{M} can be referred to either collectively or individually as service(s) 1 10, with specific subscripts typically utilized only when necessary to prevent confusion or provide more specificity. Services 110 can be substantially any wireless-based service that can be provided or facilitated by way of a Wi-Fi network. To provide a few concrete examples, service 110 can be a service that provides access to the Internet or another network or to particular applications. One particular service 110 can provide voice-based services while another provides for data. Additionally or alternatively, one particular service 110 can be free to an end user (e.g., paid for or subsidized by advertisers), and yet another service 110 can be wholly fee-based. Other services 110 can be open or unencrypted while still others are encrypted services 110.

Appreciably, selection component 106 can facilitate access to plurality 108 of wireless services based upon a single SSID. In general, an SSID is a name used to identify the particular wireless local area network(s) (LAN) to which a client desires to attach and/or the particular service(s) (provided by the LAN) the client desires to access. Typically, the wireless LAN will be an 802.11 network, and all access points to the physical network can broadcast the SSID. Of course, for a given geographical area, many different network providers can be available. Thus, a client device can receive broadcast messages from all access points within range advertising the respective SSID of the host network. Connection to one or more of these networks can be accomplished based upon pre-configuration, or by displaying a list of SSIDs (e.g., network names) in range, and allowing the client to make a selection.

Conventional Wi-Fi and/or wireless networks that provide multiple services do so by broadcasting multiple SSIDs, one for each service. Thus, each access point to a given network broadcasts a distinct SSID for each available service. Accordingly, a client device in range will be provided several SSIDs even though there might be only one physical network. Generally, this is achieved by partitioning a physical network and/or components thereof into multiple logical networks or components. Thus, a single physical network/LAN can be partitioned into multiple virtual LANs (VLANs), with each VLAN identified by a distinct SSID. Although each SSID can potentially utilize the same physical hardware, a different set of security, network, and other settings can be implemented based upon the particular VLAN selected by the client.

By way of illustration, consider Table I, infra, which provides example SSIDs that can be available in a hypothetical metropolitan location:

TABLE I

| SSID | Description |
|---|---|
| ABC-Affiliates | Access to ABC's Network |
| XYZ-Free-Wi-Fi | Access to Free Service/VLAN |
| XYZ-Full-Wi-Fi | Full Service Plan |
| XYZ-Jukebox | Access to Client Music Database |

In the first column, Table I provides an SSID, as might be displayed by a client device to allow selection of the appropriate network or service. The second column is intended to provide a brief description of the associated SSID. In this example, it is assumed that the client has a contractual service agreement with XYZ and pays for the full service plan, for which the associated SSID broadcast by XYZ access points is “XYZ-Full-Wi-Fi.” Therefore, for the purpose of this example, the SSID denoted “ABC-Affiliates” is not particularly important and provided primarily for the sake of illustrating that a client can receive an SSID broadcast from any access point within range, potentially including those from competing and/or non-subscribed networks.

“XYZ-Free-Wi-Fi” relates to a free service, potentially hosted by a disparate VLAN from that of the full service plan, although both are provided by XYZ and both will typically utilize the same physical hardware. Appreciably, since a client does not pay XYZ for access to the free service, advertisers can help defray the costs of utilizing XYZ's network, which can be negotiated independently between XYZ and various advertisers. Moreover, since access associated with the various SSIDs can employ or enforce different policies, speed, quality of service, available applications or sites, data volume, and other network features can differ from or be contingent upon the full service VLAN. For example, network resources can be prioritized to full service clients such that full service clients are allocated higher speeds, better quality, etc. and/or free service clients only receive certain speeds or quality when the resource utilization of full service clients is relatively light.

“XYZ-Jukebox” is an SSID for a special service or application that provides access to a client music database, potentially stored in a network-accessible cloud or server maintained by XYZ. Thus, a mobile client can access music by way of a network rather than through local storage, wherein the network or the client potentially enforces compliance with suitable copyright and/or licensing agreements, digital rights management (DRM), or the like. All features of the jukebox can also be provided through the full service plan, however, e.g., due to wide popularity, XYZ has decided to offer the jukebox application as a standalone service as well, for instance, at a discount to the price of the full service plan and potentially using different access protocols and the like.

In accordance with the above example and as depicted in Table I, any access point associated with XYZ can broadcast all three SSIDs. Each respective SSID will map to one of three different VLANs, wherein each VLAN hosts a separate service. Conventional network providers implement multiple services over a single physical network in just such a manner. However, utilizing multiple SSIDs for providing multiple services has a number of drawbacks.

In particular, utilizing multiple SSIDs can create confusion for users of client devices. For example, when considering the first column of Table I, which exemplifies how a client will display SSIDs, a user might readily understand that she does not want to select ABC-Affiliates, since the user pays XYZ every month for the full service. However, the user may still be confused about which of the three XYZ SSIDs to select. As one example of such, the user might in this case specifically only want to access her music database, a feature available through the full service plan for which she pays, and therefore be lead to incorrectly select the SSID associated with the jukebox.

A second disadvantage is that multiple SSIDs can dilute trademarks or trade or product names or brands. Additionally or alternatively, implementing multiple SSIDs can force the provider to register multiple trademarks, which can lead to additional expenses as well as additional potential conflicts. Because the SSID is generally the first identifier a user/client sees, the SSID is often used or at least perceived as the product brand. Accordingly, network providers can have a strong incentive to utilize a single SSID, but have heretofore been unable to do so when providing multiple servicers or multiple VLANs.

A third drawback occurs in that switching between different services is more difficult. For example, if a client wishes to switch from the free service to the full service or the jukebox service (or the like), then the client must disconnect from the session established with the first SSID and reconnect by way of the second SSID. In contrast, if only a single SSID is employed to provide multiple services, as detailed herein, then disconnection and reconnection are not necessary.

Still another disadvantage of utilizing multiple SSIDs for multiple services, as is currently implemented by conventional systems, is the need to broadcast these multiple SSIDs. Every access point of a given provider network must continuously broadcast the names of all VLANs available through that provider. As such, a conventional network provider that offers access to three VLANs must broadcast SSIDs for each VLAN, which ultimately consumes more resources than would broadcasting a single SSID.

Table II is provided infra to illustrate an example in which XYZ offers access to all services by way of a single SSID:

TABLE II

| SSID | Description |
|---|---|
| ABC-Affiliates | Access to ABC's Network |
| XYZ-Wi-Fi | Access to Multiple Services provided by XYZ |

The first column of Table II illustrates what the same client at the same location as that described in connection with Table I might display when XYZ employs only a single SSID to provide access to multiple services. Thus, rather than broadcasting three distinct SSIDs (as depicted by Table I), XYZ can broadcast only one, denoted “XYZ-Wi-Fi.” Appreciably, the many drawbacks associated with employing multiple SSIDs previously detailed, as well as other disadvantages, can be mitigated by implementing only a single SSID as is further described herein.

Continuing to refer to FIG. 1, as noted supra, selection component 106 can facilitate access to plurality 108 of wireless services 110 based upon a single SSID. In addition, selection component 106 can choose a particular service 112 from among plurality 108 (e.g., service 110₁, 110₂ . . . 110_{M}) based at least in part upon an identity of the client. In particular, once the client is identified and/or authenticated by authentication component 102 based upon client credential 104, selection component 106 can access account information associated with the client in order to identify which service 110 is provisioned for that client. Hence, the suitable provisioned service 112 can thus be selected by selection component 106.

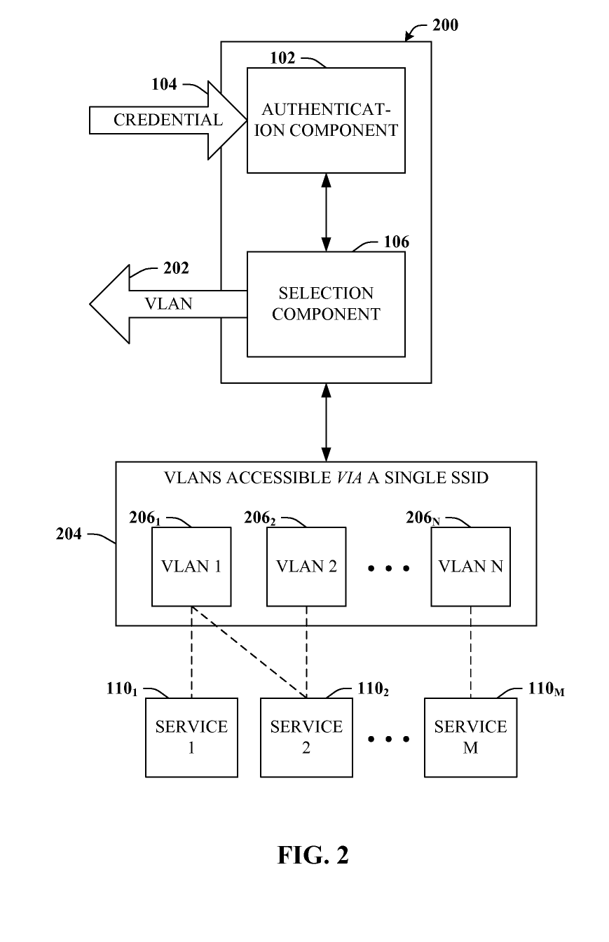

According to an aspect of the disclosed subject matter, selection component 106 can choose the particular service 112 further based upon a preference or selection associated with the client. In an aspect of the disclosed subject matter, selection component 106 can be configured to facilitate access to a plurality of VLANs based upon a single SSID, as is depicted in more detail in connection with FIG. 2.

Turning now to FIG. 2, system 200 that can employ a single SSID for connecting to multiple VLANs in a wireless communication environment is provided. Appreciably, system 200 can be substantially similar to system 100 described supra with reference to FIG. 1. In particular, system 200 can include authentication component 102 that can identify and/or authenticate a client based upon client credentials 104 received (either directly or indirectly) from the client. However, in addition to or in the alternative to providing access to plurality 108 of services based upon a single SSID, selection component 106 can also provide access to plurality 204 of VLANs, which are denoted as VLANs 206₁-206_{N} (N being an integer greater than or equal to 2) and referred to either collectively or individually as VLANs 206. Hence, selection component 106 can choose a particular VLAN 202 from among plurality 204 based upon the identity of the client in a manner similar to that which was described above regarding choosing a particular service 112.

Oftentimes a network provider will construct a different VLAN 206 for each service 110 the provider desires to make available to end-user clients. Thus, the provider can map each SSID to an associated VLAN 206. However, such need not always be the case. For example, it can be readily understood that a single VLAN 206 can host or provide access to multiple services 110. An example of this is illustrated by VLAN 206₁, which can provide access to one or both of services 110₁ or 110₂. Conversely, it can also be envisioned that a given service 110 can be provided by more than one VLAN 206 as depicted by service 110₂ that is accessible by way of VLANs 206₁ and 206₂. However, it should be appreciated that different policies for service 110₂ can be enforced depending upon which VLAN 206 is utilized.

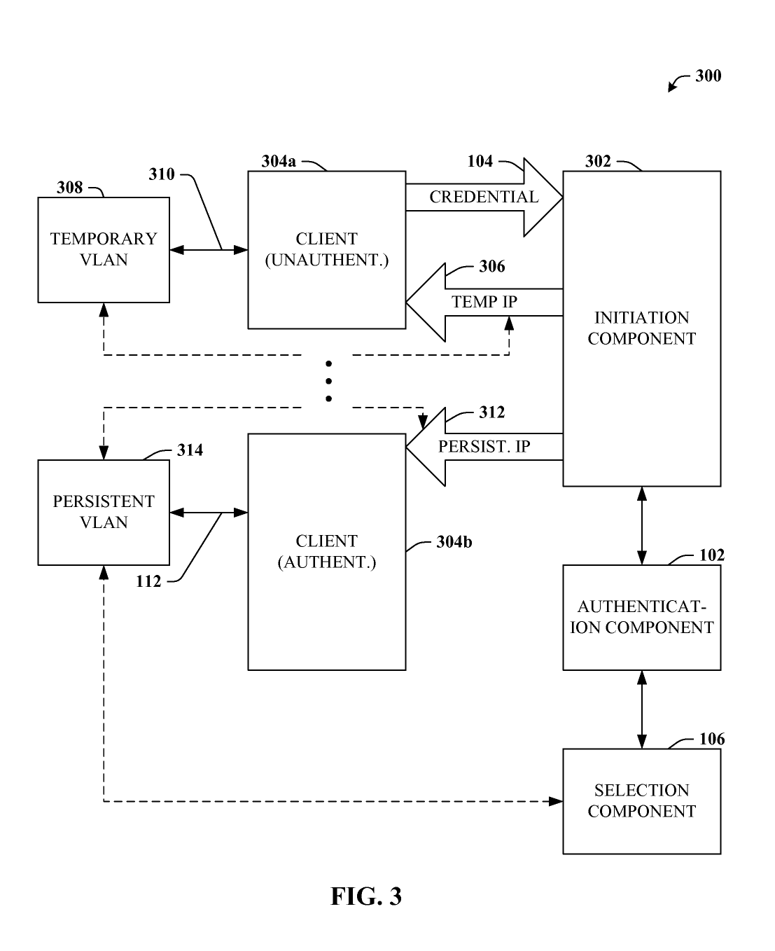

Now referring to FIG. 3, system 300 that can initiate a connection with access to multiple VLANs or services by way of a single SSID is illustrated. In general, system 300 can include initiation component 302 that can receive a service session request from unauthenticated client 304a. For example, the service session request can result from a selection of a broadcast SSID, such as the single SSID described herein. Based upon an initial request to establish a connection, initiation component 302 can assign and provide to unauthenticated client 304a temporary Internet protocol (IP) address 306. For example, upon establishing a connection to a physical network (e.g., by way of the broadcast SSID), unauthenticated client 304a can make a dynamic host configuration protocol (DHCP) request for an IP address, which can be provided by initiation component 302 as temporary IP address 306.

Generally, temporary IP address 306 will map to temporary VLAN 308, as illustrated by the broken lines. Temporary VLAN 308 can be either ad hoc or persistent and can be provided expressly for the purpose of supporting initial connections to the network, logging in to the network, registration and so forth. In an aspect of the disclosed subject matter, temporary IP address 306 can be allocated based upon a very short-term lease. For instance, the duration of the short-term lease can be measured in seconds or minutes and will typically expire after one or two minutes.

Accordingly, unauthenticated client 304a can provide credentials 104, which can be received by initiation component 302 and forwarded to authentication component 102, or in some cases transmitted directly to authentication component 102. It should be appreciated that credential 104 can be based upon a client login of substantially any suitable means. As one example, once provided temporary IP address 306, client 304a can open a web browser, be redirected to a login website where authentication information can be input. Unauthenticated client 304a can also employ temporary IP address 306 to browse available service option, register as a new user, review account information, set preferences, and other suitable activities.

Regardless, authentication component 102 can authenticate the client as detailed supra. Accordingly, once credential 104 is utilized to authenticate and/or ascertain an identity, unauthenticated client 304a can thus become authenticated client 304b. Based upon the identity of authenticated client 304b, selection component 106 can select a provisioned service associated with authenticated client 304b. Initiation component 302 can then generate persistent IP address 312 that maps to persistent VLAN 314, wherein persistent VLAN 314 hosts the service provisioned to authenticated client 304b. Appreciably, persistent IP address 312 can be assigned to authenticated client 304b such that authenticated client 304b has access to the provisioned service 112 and/or VLAN 314 determined by selection component 106.

It should be understood that initiation component 302 can assign persistent IP address 312 to authenticated client 304b based upon an active request from authenticated client 304b. However, more typically, initiation component 302 will assign persistent IP address 312 to authenticated client 304b upon expiration of the very short term lease associated with temporary IP address 306. It should be further appreciated that while denoted as “persistent,” IP address 312 can be dynamically assigned as is known in the art rather than allocating a static IP address for a particular client.

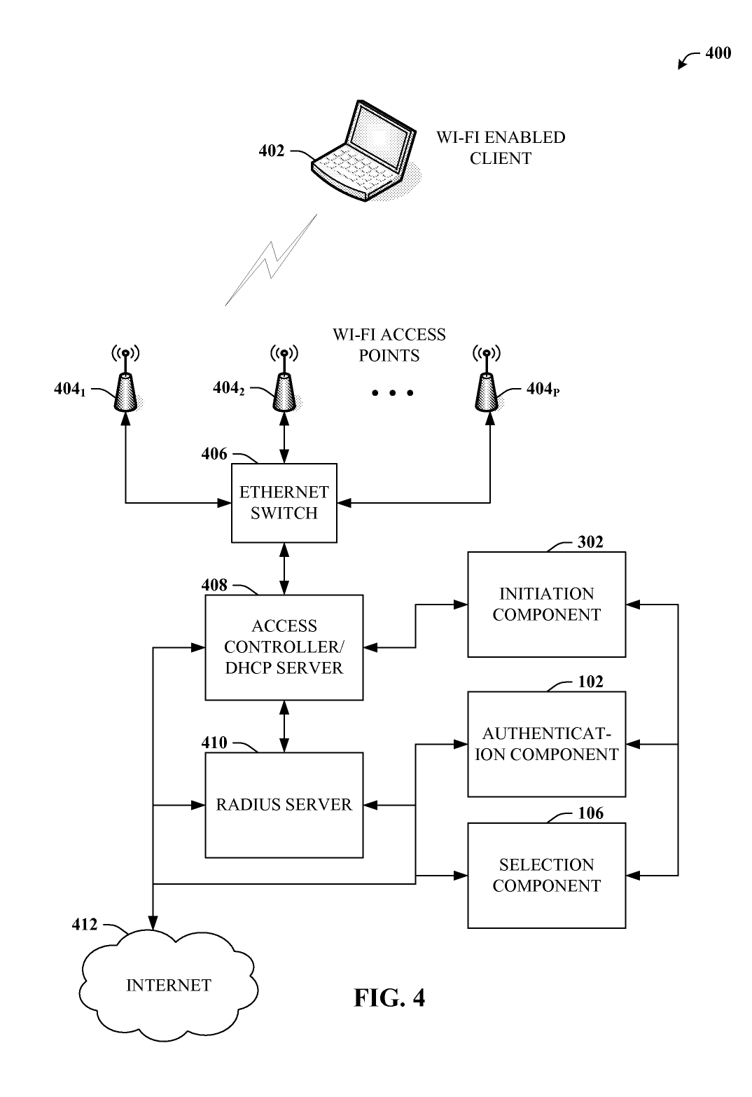

Turning now to FIG. 4, exemplary system 400 that illustrates one embodiment of the claimed subject matter is depicted. It should be appreciated and understood that system 400 represents only one implementation, and numerous other configurations can be readily envisioned. As depicted, client 402 can be in range of one or more access points 404₁-404_{P}, where P is a positive integer and where access points 404₁-404_{P} can be referred to either collectively or individually as access point 404. Client 402 can be substantially any wireless and/or Wi-Fi enabled device such as a PC, tablet, or laptop, a cellular phone, a personal digital assistant (PDA), a media player, or the like.

Initially, client 402 can receive an SSID from one or several of access points 404. While only a single SSID is broadcast from the access points 404, access to a variety of services or VLANs can be obtained by way of the single SSID. Appreciably, all traffic to and from access points 404 can be handled by one or more Ethernet switches 406. Once a physical connection is established, client 402 can initiate a DHCP request for an IP address. This request can be received by access controller 408, which can include or be operatively coupled to a DHCP server. In response, client 402 can be provided a temporary IP address with a very short term lease as was described in connection with initiation component 302 of FIG. 3.

Although client 402 has been provided an IP address, client 402 is not at this stage authenticated. However, once client 402 provides client credentials, these credentials can be forwarded by access controller 408 to RADIUS server 410 for authentication. Hence, it can be readily appreciated that authentication component 102 and/or selection component 106 can be included in or be operatively coupled to RADIUS server 410. RADIUS server 410 authentication can include a type of service provisioned, ID of the VLAN to map client 402 to, as well as other suitable information. When DHCP lease expires, client 402 can make another DHCP request for an IP address. Access controller/DHCP server 408 can assign a new (persistent) IP address to client 402 for the appropriate VLAN based upon the instructions included in the RADIUS server 410 response. Upon obtaining the persistent IP address, client 402 can then access Internet 412 or another network provided by the provisioned service.

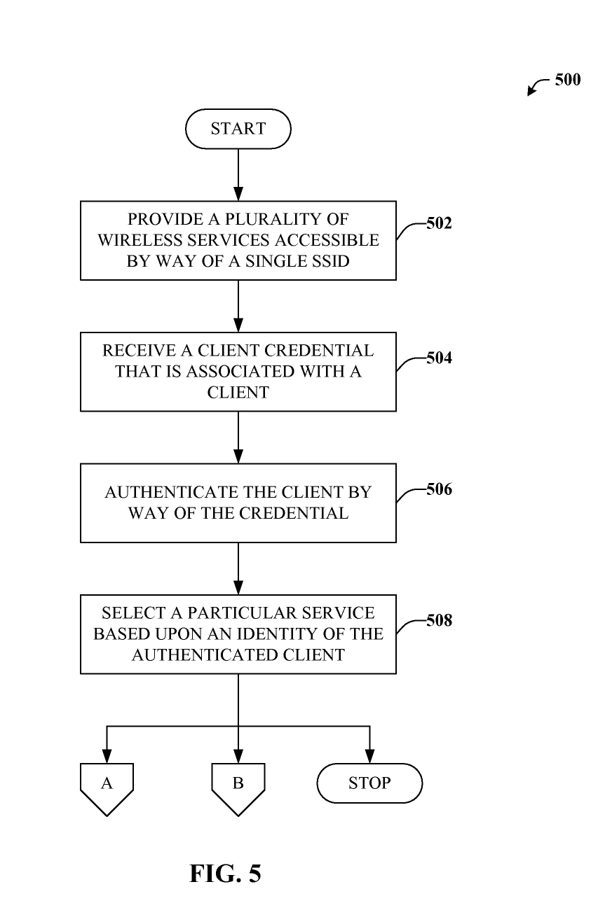

FIGS. 5, 6, 7, 8, and 9 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

With reference now to FIG. 5, example method 500 for facilitating access to a plurality of wireless services based upon a single SSID is provided. Generally, at reference numeral 502, a plurality of wireless services can be provided, all of which can be accessible by way of a single SSID. Appreciably, contemporary networks that support multiple services do so by broadcasting multiple SSIDs rather than by way of a single SSID.

At reference numeral 504, client credentials associated with a client can be received, and at reference numeral 506, the client can be authenticated and/or identified by way of the client credentials. Once the client has been identified and/or authenticated, a particular service can be selected from amongst the plurality of wireless services based upon the identity of the authenticated client. For example, a service provisioned to a registered customer can, once the customer is authenticated/identified, be selected for that customer.

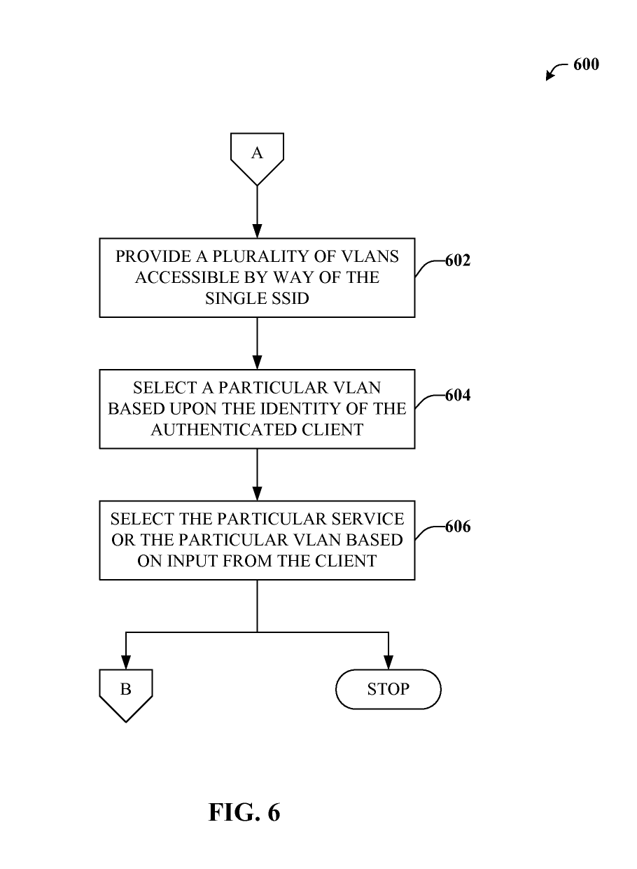

Referring to FIG. 6, exemplary method 600 for facilitating access to a plurality of wireless VLANs based upon a single SSID is depicted. At reference numeral 602, a plurality of VLANs can be provided that are accessible by way of a single SSID. For example, each VLAN from the plurality of VLANs can accommodate one or more services from the plurality of services discussed supra in connection with FIG. 5.

Next to be detailed, at reference numeral 604, a particular VLAN from amongst the plurality of VLANs can be selected based upon the identity of the authenticated client (e.g., the client authenticated at reference numeral 506 of FIG. 5). Accordingly, the VLAN can be selected based upon account information associated with the authenticated client. At reference numeral 606, the particular service or the particular VLAN can be selected further based upon a preference or selection associated with the client.

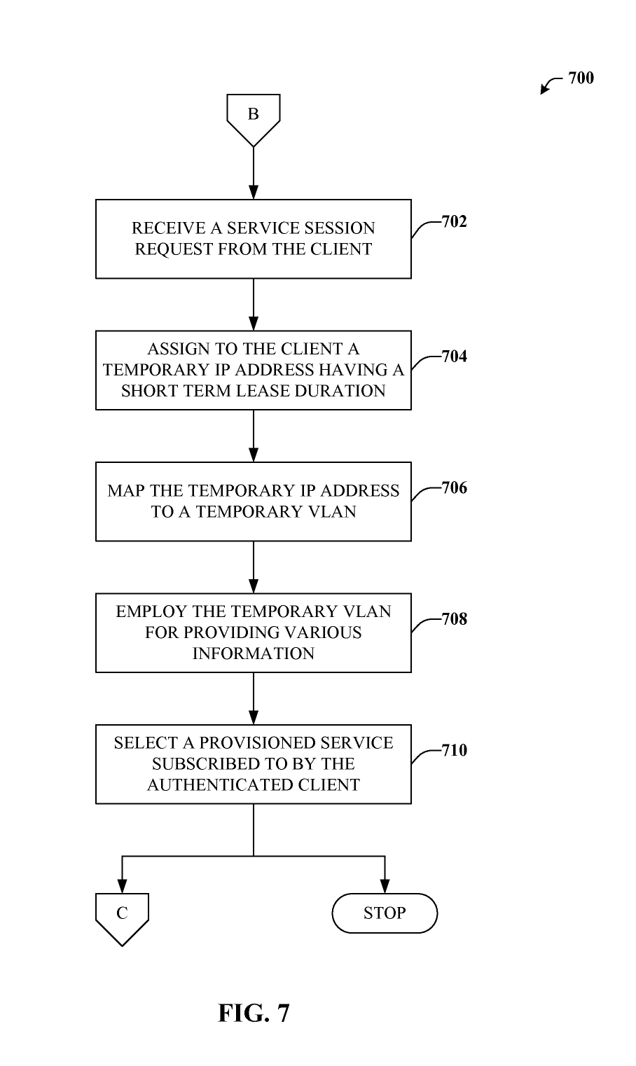

With reference now to FIG. 7, method 700 for generating a temporary IP address to an unauthenticated client in connection with accessing multiple services or VLANs by way of a single SSID is illustrated. Generally, at reference numeral 702, a service session request can be received from the client. Typically, such a request will be in the form of a DHCP request, however, other suitable protocols or requests can be employed as well without departing from the spirit or scope of the claimed subject matter.

At reference numeral 704 a temporary IP address having a very short term lease duration can be assigned to the client. For example, the lease duration for the temporary IP address can be a matter of a few minutes or the like. At reference numeral 706 the temporary IP address can be mapped to a temporary VLAN such as a VLAN provided expressly for the purposes of logging in, registering, setting preferences and so forth, as further detailed infra in connection with reference numeral 708.

At reference numeral 708 the temporary VLAN can be employed for providing at least one of a product or a service offer, a client login, a new client registration option, a client preference option, or a service selection option. At reference numeral 710, a provisioned service subscribed to by the authenticated client can be selected.

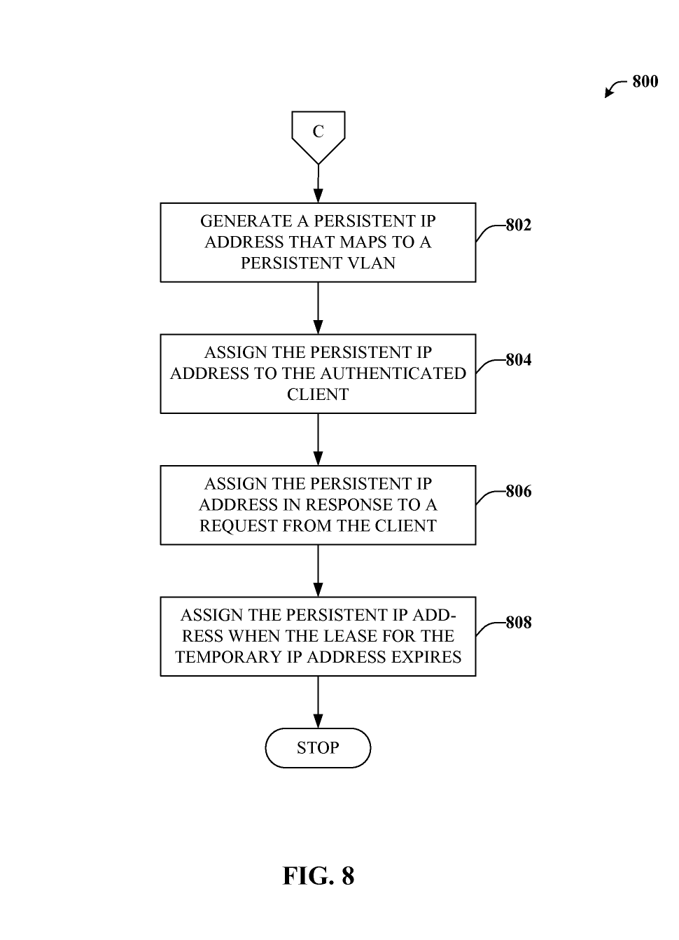

Turning now to FIG. 8, method 800 for generating a persistent IP address to an authenticated client in connection with accessing multiple services or VLANs by way of a single SSID is depicted. At reference numeral 802, a persistent IP address that maps to a persistent VLAN associated with the provisioned service can be generated. Appreciably, the persistent IP address can be dynamically assigned from a range of IP addresses associated with the particular persistent VLAN.

At reference numeral 804, the persistent IP address can be assigned to the authenticated client. In an aspect of the disclosed subject matter, the persistent IP address can be assigned to the authenticated client at reference numeral 806 in response to a request from the authenticated client. For example, the authenticated client can transmit a DHCP request for the persistent IP address subsequent to being assigned the temporary IP address detailed at reference numeral 704 of FIG. 7. Additionally or alternatively, at reference numeral 808, the persistent IP address can be assigned to the authenticated client when the very short term lease for the temporary IP address expires.

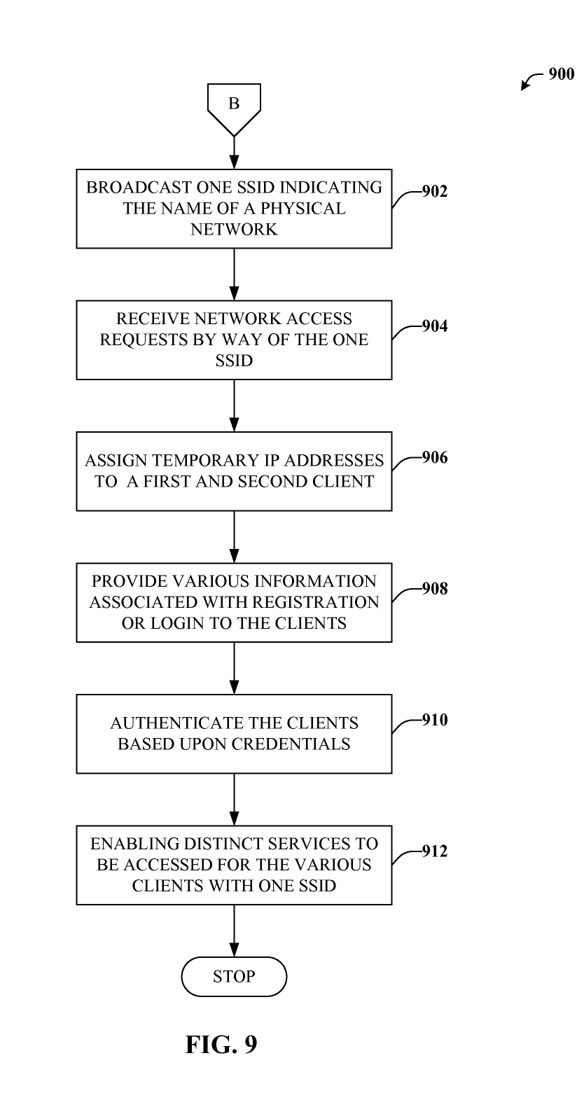

With reference now to FIG. 9, method 900 for utilizing a single SSID for enabling access to multiple services or VLANs is illustrated. In general, at reference numeral 902, one SSID indicating the name of a physical network can be broadcast. For example, the SSID can be broadcast from one or more access points. At reference numeral 904, a first network access request can be received from a first unauthenticated client. In addition, a second network access request can be received from a second unauthenticated client, wherein both the first and the second access requests solicit access to the physical network by way of the one SSID.

In accordance with the above, at reference numeral 906, a first temporary IP address can be assigned to the first unauthenticated client and a second temporary IP address can be assigned to the second unauthenticated client, wherein the first and the second temporary IP addresses can be distinct from one another. At reference numeral 908, at least one of a login features or a registration feature can be provided by way of a temporary VLAN associated with the physical network, wherein both the first and the second temporary IP address are associated with the temporary VLAN. For instance, both the first and the second unauthenticated client can access the temporary VLAN provided for logging in or registering by utilizing one of a range of IP addresses associated with the temporary VLAN.

At reference numeral 910, both the first and the second client can be authenticated by way of respective client credentials. In other words, the first and second unauthenticated client can become first and second authenticated clients, respectively, upon supplying suitable credentials. At reference numeral 912, a first service can be enabled for the first authenticated client and a second service can be enabled for the second authenticated client, wherein the first service differs from the second service. Hence, although both the first and the second clients accessed the physical network by way of an identical SSID, each is provided access to a separate or distinct service.

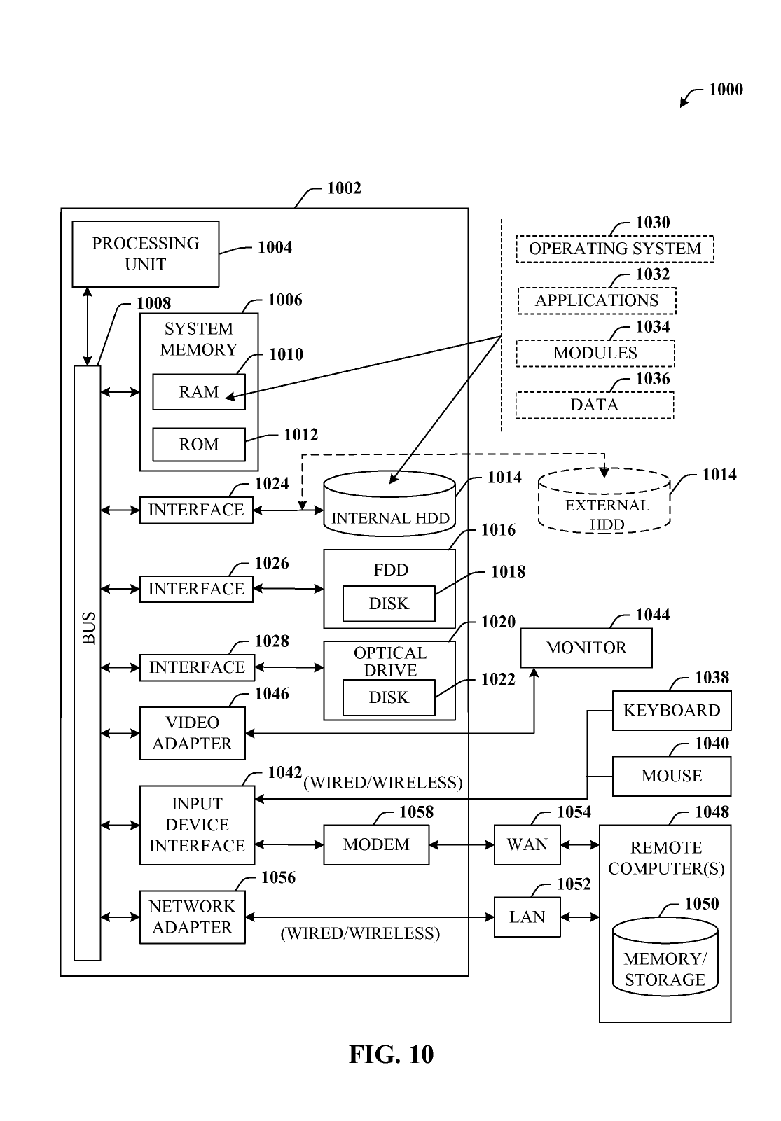

Referring now to FIG. 10, there is illustrated a block diagram of an exemplary computer system operable to execute the disclosed architecture. In order to provide additional context for various aspects of the claimed subject matter, FIG. 10 and the following discussion are intended to provide a brief, general description of a suitable computing environment 1000 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the claimed subject matter includes a computer 1002, the computer 1002 including a processing unit 1004, a system memory 1006 and a system bus 1008. The system bus 1008 couples to system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the claimed subject matter can be implemented with various commercially available operating systems or combinations of operating systems.

A user can enter commands and information into the computer 1002 through one or more wired/wireless input devices, e.g. a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g. a wide area network (WAN) 1054. Such LAN and WAN networking environments are commonplace in offices and companies, and facilitate enterprise-wide computer networks, such as intranets, all of which may connect to a global communications network, e.g. the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11b) or 54 Mbps (802.11a) data rate, for example, or with products that contain both bands (dual band), so the networks can provide real-world performance similar to the basic “10BaseT” wired Ethernet networks used in many offices.

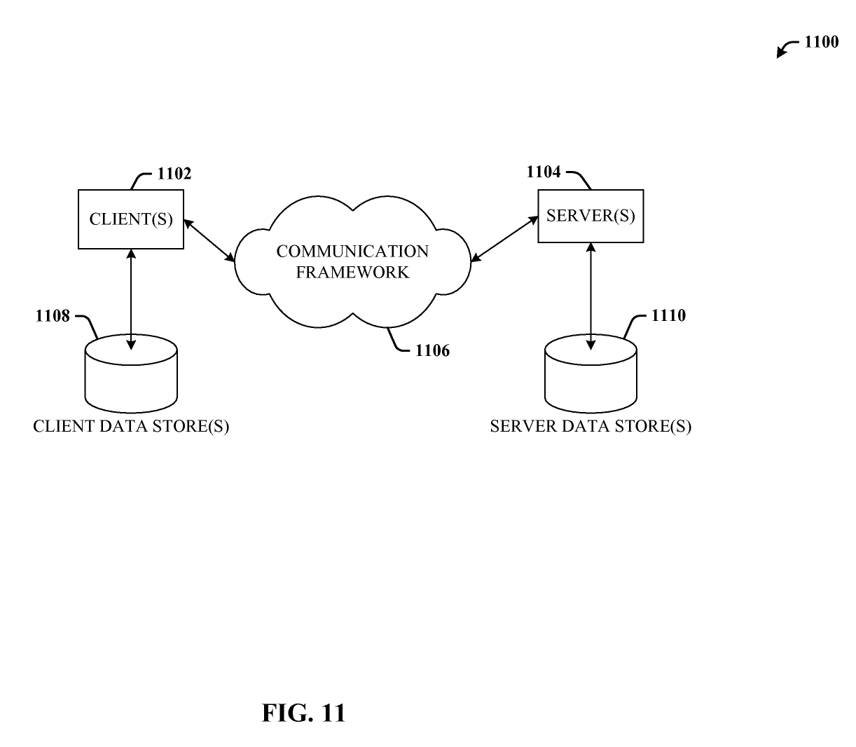

Referring now to FIG. 11, there is illustrated a schematic block diagram of an exemplary computer compilation system operable to execute the disclosed architecture. The system 1100 includes one or more client(s) 1102. The client(s) 1102 can be hardware and/or software (e.g., threads, processes, computing devices). The client(s) 1102 can house cookie(s) and/or associated contextual information by employing the claimed subject matter, for example.

The system 1100 also includes one or more server(s) 1104. The server(s) 1104 can also be hardware and/or software (e.g., threads, processes, computing devices). The servers 1104 can house threads to perform transformations by employing the claimed subject matter, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. 1. A system that employs a single service set identifier (SSID) for connecting to multiple services in a wireless communication environment, comprising:
an authentication component that receives a client credential and that authenticates or identifies an associated client based upon the client credential; and
a selection component that is configured to facilitate access to a plurality of wireless services based upon a single SSID, the selection component chooses a particular service from among the plurality of wireless services based at least in part upon an identity of the client.

2. The system of claim 1, the selection component is configured to facilitate access to a plurality of virtual local area networks (VLANs) based upon a single SSID.

3. The system of claim 2, the selection component chooses a particular VLAN from among the plurality of VLANs based at least in part upon the identity of the client.

4. The system of claim 1, the selection component chooses the particular service further based upon a preference or selection associated with the client.

5. The system of claim 1, further comprising an initiation component that receives a service session request from the client and that assigns to the client a temporary Internet protocol (IP) address with a very short term lease.

6. The system of claim 5, the temporary IP address maps to a temporary VLAN.

7. The system of claim 6, the temporary VLAN provides at least one of a product or service offer, a client login, a new client registration option, a client preference option, or a service selection option.

8. The system of claim 5, the initiation component further receives the client credential from the client and forwards the client credential to the authentication component.

9. The system of claim 8, the selection component selects a provisioned service associated with the client, and the initiation component generates a persistent IP address that maps to a persistent VLAN that hosts the provisioned service.

10. The system of claim 9, the initiation component assigns to an authenticated client the persistent IP address.

11. The system of claim 10, the initiation component assigns the persistent IP address in response to a request from the authenticated client.

12. The system of claim 10, the initiation component assigns the persistent IP address to the authenticated client upon expiration of the temporary IP address.

13. A method for facilitating access to a plurality of wireless services based upon a single SSID, comprising:
providing a plurality of wireless services accessible by way of a single SSID;
receiving a client credential that is associated with a client;
authenticating the client by way of the credential; and
selecting a particular service from amongst the plurality of wireless services based upon an identity of the authenticated client.

14. The method of claim 13, further comprising providing a plurality of VLANs accessible by way of the single SSID, each VLAN from the plurality of VLANs accommodates one or more services from the plurality of services.

15. The method of claim 14, further comprising selecting a particular VLAN from amongst the plurality of VLANs based upon the identity of the authenticated client.

16. The method of claim 15, further comprising selecting the particular service or the particular VLAN further based upon a preference or selection associated with the client.

17. The method of claim 13, further comprising at least one of the following acts:
receiving a service session request from the client;
assigning to the client a temporary IP address having a very short term lease duration;
mapping the temporary IP address to a temporary VLAN;
employing the temporary VLAN for providing at least one of a product or service offer, a client login, a new client registration option, a client preference option, or a service selection option; or
selecting a provisioned service subscribed to by the authenticated client.

18. The method of claim 17, further comprising at least one of the following acts:
generating a persistent IP address that maps to a persistent VLAN associated with the provisioned service;
assigning the persistent IP address to the authenticated client;
assigning the persistent IP address to the authenticated client in response to a request from the authenticated client; or
assigning the persistent IP address to the authenticated client when the very short term lease for the temporary IP address expires.

19. A method for utilizing a single SSID for enabling access to multiple services or VLANs, comprising:
broadcasting one SSID indicating the name of a physical network;
receiving a first network access request from a first unauthenticated client and a second network access request from a second unauthenticated client, both the first and the second access requests solicit access to the physical network by way of the one SSID;
assigning a first temporary IP address to the first unauthenticated client and a second temporary IP address to the second unauthenticated client;
providing at least one of a login feature or a registration feature by way of a temporary VLAN associated with the physical network, both the first and the second temporary IP addresses are associated with the temporary VLAN;
authenticating both the first and the second client by way of respective client credentials for establishing a first authenticated client and a second authenticated client, respectively; and
enabling a first service for the first authenticated client and a second service for the second authenticated client, the first service is distinct from the second service.

20. The method of claim 19, the first service is hosted by a first VLAN and the second service is hosted by a second VLAN that is distinct from the first VLAN.
